(19) United States
(12) Patent Application Publication
(10) Pub. No.: US 2024/0122243 A1
(43) Pub. Date: Apr. 18, 2024

(54) Aerosol Generation System with Thermal Regulation Mechanism

(71) Applicant: JT International SA, Genèva (CH)

(72) Inventors: Alec Wright, Guildford (GB); Andrew Robert John Rogan, Forres (GB); Madoka Hasegawa, Nyon (CH)

(73) Assignee: JT International SA, Geneva (CH)

(21) Appl. No.: 18/019,688

(22) PCT Filed: Jul. 14, 2021
(86) PCT No.: PCT/EP2021/069602

§ 371 Date: Feb. 3, 2023

(30) Foreign Application Priority Data
Aug. 4, 2020 (EP) 20189390.6

(51) Int. Cl. A24F 40/46; F03G 7/06

(52) U.S. Cl. CPC A24F 40/46; F03G 7/0614

(57) ABSTRACT

The invention relates to an aerosol generation system comprising an aerosol generation device having a heating element and a consumable for use with the aerosol generation device. The heat transfer element can be heated by the heating element of the aerosol generation device when the consumable is attached to the aerosol generation device. The heat transfer element is configured to be deformed when its temperature is at or above a threshold temperature, such that an area of contact, which exists between the heating element and the heat transfer element when the consumable is attached to the aerosol generation device and the temperature of the heat transfer element is below the threshold temperature, can be reduced, or eliminated.

### FIELD OF INVENTION

The invention relates to an aerosol generation system comprising an aerosol generation device and a consumable for use with the aerosol generation device. In particular, the invention relates to a consumable comprising a heat transfer element that is configured to be deformed when heated above a threshold temperature.

### TECHNICAL BACKGROUND

Common aerosol generation systems available on the market comprise a consumable with an aerosol generation substrate and an aerosol generation device for heating the aerosol generation substrate contained in the consumable. Some configurations of aerosol generation systems provide indirect heating of the aerosol generation substrate in the consumable by the aerosol generation device. The aerosol generation device is provided with a heating element and the consumable is provided with a heat transfer element that is heated by the heating element when the consumable is in use with the aerosol generation device. The heat transfer element transfers the heat from the heating element to the aerosol generation substrate for generating an aerosol for consumption by a user.

Indirect heating is advantageous because it aids in avoiding overheating of the aerosol generation substrate, and different configurations are employed for regulating and controlling the heating temperature of the aerosol generation substrate for preventing overheating. However, current configurations for providing indirect heating are disadvantageous. In some configurations, the heating temperature of the aerosol generation substrate is estimated based on the temperature of the heating element. These configuration are simple and responsive, but inaccurate. Some configurations employ a dedicated temperature sensor provided near the aerosol generation substrate to measure the heating temperature of the aerosol generation substrate. While these configuration afford a more accurate temperature measurement, temperature measurement is less responsive, and due to the additional electronic components, manufacturing is expensive.

Therefore, there is a need for an aerosol generation system that provides simple, cost-effective, responsive, and accurate control of the heating temperature of the aerosol generation substrate for preventing overheating of the aerosol generation substrate.

### SUMMARY OF THE INVENTION

Some, or all of the above problems are solved by the invention as defined by the features of the independent claims. Preferred embodiments of the invention are defined by the features of the dependent claims.

A 1^{st} aspect of the invention is a consumable for use with and attachable to an aerosol generation device comprising a heating element, the consumable comprising an aerosol generation substrate and a heat transfer element for heating the aerosol generation substrate for generating an aerosol. The heat transfer element can be heated by the heating element of the aerosol generation device when the consumable is attached to the aerosol generation device. The heat transfer element is configured to be deformed when its temperature is at or above a threshold temperature, whereby the area of a contact, which exists between the heating element and the heat transfer element when the consumable is attached to the aerosol generation device and the temperature of the heat transfer element is below the threshold temperature, can be reduced, or the contact can be eliminated. Because the contact between the heating element and the heat transfer element can be reduced or eliminated when the heat transfer element reaches the threshold temperature, this configuration allows the temperature of the heat transfer element and consequently the temperature of the aerosol generation substrate to be controlled to be below the threshold temperature to prevent overheating. This affords reliable, responsive, and accurate temperature control of the heat transfer element and the aerosol generation substrate without the need for additional electrical and electronic components that drive up the manufacturing complexity and cost.

According to a 2^{nd} aspect, in the preceding aspect, the heat transfer element is configured to be deformed when its temperature is at or above the threshold temperature. Reducing the area of contact or eliminating the contact between the heat transfer element and the heating element when the consumable is in use can be achieved by a deformation of the heat transfer element.

According to a 3^{rd} aspect, in the preceding aspect, the heat transfer element is configured to be elastically deformed when its temperature is at or above the threshold temperature and to substantially be reset to its original shape when its temperature is subsequently at a temperature below the threshold temperature. Resetting to its original shape at a temperature below the threshold temperature allows the temperature of the heat transfer element to be repeatedly controlled.

According to a 4^{th} aspect, in any one of the preceding aspects, the heat transfer element comprises or substantially consists of a material that exhibits a thermostatic behaviour. Materials with a thermostatic behaviour are suitable for controlling the temperature of the heat transfer element below the threshold temperature.

According to a 5^{th} aspect, in any one of the 1^{st} or 2nd aspects, the heat transfer element comprises or substantially consists of a shape memory alloy (SMA), and the threshold temperature corresponds to the transformation temperature of the SMA.

According to a 6^{th} aspect, in the preceding aspect, the heat transfer element is configured to be deformed when its temperature is at or above the transformation temperature such that at least a portion or all of the heat transfer element can be retracted from the heating element. The 5^{th} and 6^{th} aspects are advantageous because SMAs are metal alloys that undergo a phase change when heated that allows them to be deformed when at or above their transformation temperature. This makes them suitable as a material for the heat transfer element. Depending on the material, SMAs may exhibit a one-way memory effect or a two-way memory effect.

According to a 7^{th} aspect, in any one of the 5^{th} or 6^{th} aspects, the heat transfer element is configured to substantially remain in its deformed shaped once deformed even when its temperature is subsequently at a temperature below the transformation temperature. SMAs with a one-way memory effect are deformed when heated to or above the transformation temperature and are not reset to their original shape when subsequently at a temperature below the transformation temperature. This allows SMAs to perform a fuse function that is triggered when the heat transfer element is heated to a temperature at or above the well-defined transformation temperature, and the temperature of the heat transfer element can be controlled to be below the transformation temperature for preventing overheating.

According to an 8^{th} aspect, in any one of the 1^{st} to 3^{rd} aspects, the heat transfer element comprises or substantially consists of a shape memory alloy (SMA), and the threshold temperature corresponds to the transformation temperature of the SMA.

According to a 9^{th} aspect, in the preceding aspect, the heat transfer element is configured to substantially be reset to its original shape when its temperature reaches a temperature below the transformation temperature. The 8^{th} and 9^{th} aspects are advantageous because SMAs with a two-way memory effect are deformed when heated to or above the transformation temperature and are reset to their original shape when subsequently at a temperature below the transformation temperature. This allows the heat transfer element to perform a switch function for temperature control at a well-defined temperature, and the temperature of the heat transfer element can be repeatedly controlled to be below the transformation temperature for preventing overheating.

According to a 10^{th} aspect, in the preceding aspect, if the heat transfer element is at or above a second threshold temperature that is higher than the transformation temperature, the heat transfer element is configured to substantially remain in its deformed shaped once deformed even when its temperature is subsequently at a temperature below the transformation temperature. Some SMAs exhibit a two-way memory effect when below the transformation temperature and exhibit a one-way memory effect when heated to or above a second threshold temperature that is above the transformation temperature. This allows the heat transfer element to perform both a switch function and a fuse function at respective well-defined temperatures.

According to an 11^{th} aspect, in any one of the 5^{th} to 10^{th} aspects, the SMA comprises or substantially consist of Cu—Al—Ni. Copper-Aluminum-Nickel (Cu—Al—Ni) is advantageous because it is cost-efficient to produce, can be configured to have a transformation temperature above 100° C. and has a small hysteresis.

According to a 12^{th} aspect, in any one of the 1^{st} to 4^{th} aspects, the heat transfer element comprises or substantially consists of a bimetallic material.

According to a 13^{th} aspect, in the preceding aspect, the heat transfer element is configured to deform as a function of its temperature such that at or above the threshold temperature, at least a portion or all of the heat transfer element can be retracted from the heating element. Bimetallic materials typically consist of two metal materials that are bonded together. Because the two materials exhibit different thermal expansion rates, the bimetallic material deforms when heated. Bimetallic materials are advantageous because their deformation can be used to retract all or a portion of the heat transfer element from the heating element. Additionally, since the deformation of bimetallic materials is a gradual and reversible process, using bi-metallic materials affords repeated and greater control over the contact area between the heating element and the heat transfer element over a range of temperatures.

According to a 14^{th} aspect, in any one of the 12^{th} or 13^{th} aspect, the bimetallic material comprises or substantially consists of steel and copper, or steel and brass. Steel and copper or steel and brass are commonly available bimetallic materials and are cost-efficient during manufacture.

According to a 15^{th} aspect, in any one of the 1^{st} to 3^{rd} aspects, the heat transfer element comprises or substantially consists of a magnetic material such that, when the heating element of the aerosol generation device comprises or substantially consists of a magnetic material, an attractive magnetic force between the heating element and the heat transfer element may cause the contact between the heating element and the heat transfer element to be established when the temperature of the heat transfer element is below the threshold temperature. The attractive magnetic force between different magnetic materials can be used for ensuring that the heating element and the heat transfer element remain in contact when the consumable is in use with the aerosol generation device. Utilizing a magnetic force is further advantageous because magnetic interactions are not subject to mechanical wear and tear that can occur with repeated use.

According to a 16^{th} aspect, in the preceding aspect, the threshold temperature is the Curie temperature of the heat transfer element, and the attractive magnetic force between the heating element and the heat transfer element can be reduced or eliminated at or above the Curie temperature of the heat transfer element such that at least a portion or all of the heat transfer element is retracted from the heating element. When a magnetic material is heated to or above its Curie temperature, the material may undergo a change in its magnetic properties. This is advantageous because the attractive magnetic force can be weakened or eliminated, and as a result, the contact area between the heating element and the heat transfer element can be reduced or the contact can be eliminated. Therefore, the magnetic phase change at the Curie temperature can be reliably used to allow the heat transfer element to perform a switch or fuse function at a well-defined temperature.

According to a 17^{th} aspect, in any one of the preceding aspects, the heat transfer element comprises or consists of a strip or sheet and/or membrane that is bent or curved when its temperature is below the threshold temperature. This improves the reliability of the contact between the heating element and the heat transfer element, and also improves the performance of the heat transfer element as a temperature switch or fuse. A strip or membrane in a curved or bent shape provides a well-defined contact when the heat transfer element is contacting the heating element, and further defines a predictable deformation of the heat transfer element to provide a reliable and predictable switching or fuse function of the heat transfer element.

According to an 18^{th} aspect, in any one of the preceding aspects, the aerosol generation substrate comprises a liquid or tobacco material.

A 19^{th} aspect of the invention is an aerosol generation device for use with a consumable according to the 15^{th} aspect, the aerosol generation device comprising a heating element that comprises or substantially consists of a magnetic material, wherein the threshold temperature is the Curie temperature of the heating element, and the attractive magnetic force between the heating element and the heat transfer element can be reduced or eliminated at or above the Curie temperature of the heating element such that at least a portion or all of the heat transfer element is retracted from the heating element. The advantages of the 19^{th} aspect are analogous to the advantages of the 15th and 16^{th} aspects.

A 20^{th} aspect of the invention is an aerosol generation device according to the preceding claim, wherein the heating element of the aerosol generation device is an electrical heating element and the aerosol generation device comprises an electrical power source for supplying power to the heating element. In contrast to other power sources such as combustible power sources, electrical power sources are advantageous because they are reliable, predictable, easily exchangeable, rechargeable, and compact in size.

A 21^{st} aspect of the invention is an aerosol generation system comprising a consumable according to any one of claims 1 to 18 and an aerosol generation device comprising a heating element configured for heating the heat transfer element of the consumable when the consumable is attached to the aerosol generation device. The advantages of the 21^{st} aspect are analogous to the advantages of any one of the 1^{st} to 18^{th} aspects.

According to a 22^{nd} aspect, in the preceding aspect, the heating element of the aerosol generation device is an electrical heating element and the aerosol generation device comprises an electrical power source for supplying power to the heating element. The advantages of the 22^{nd} aspect are analogous to the advantages of the loth aspect.

A 23^{rd} aspect of the invention is an aerosol generation system comprising a consumable according to the 15^{th} aspect and an aerosol generation device according to any one of the 19^{th} or loth aspect. The advantages of the 23^{rd} aspect are analogous to the advantages of the 15^{th} and the 19^{th} or loth aspects.

According to a 24^{th} aspect, in any one of the 21^{st} to 23^{rd} aspects, the aerosol generation system is an e-cigarette.

### BRIEF DESCRIPTION OF THE DRAWINGS

FIG. 1 shows a schematic illustration of an aerosol generation system comprising a consumable at a first temperature in use with an aerosol generation device, according to embodiments of the present invention;

FIG. 2 shows a schematic illustration of an aerosol generation system comprising a consumable at a second temperature in use with an aerosol generation device, according to embodiments of the present invention;

FIG. 3 shows a schematic illustration of an aerosol generation system comprising a consumable at a third temperature in use with an aerosol generation device, according to embodiments of the present invention.

### DETAILED DESCRIPTION OF PREFERRED EMBODIMENTS

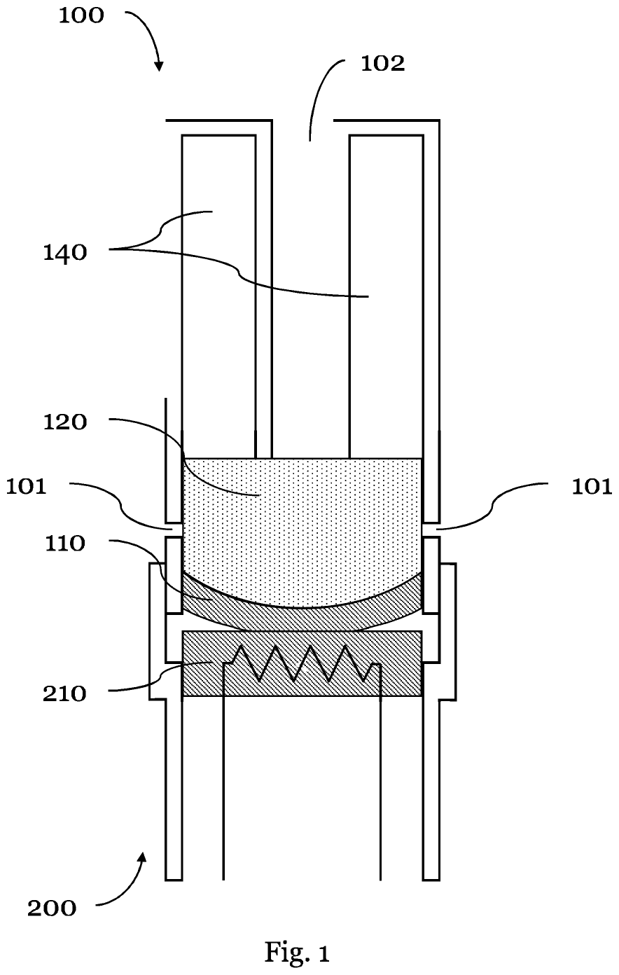

FIG. 1 shows a schematic illustration of a consumable 100 that is in use with an aerosol generation device 200 that comprises a heating element 210. The heating element 210 may be an electrical heating element comprising a resistive heater or any suitable heater type. The aerosol generation device 200 may be provided with a power source for providing power to the heating element 210. The power source may be an electrical power source such as a battery that may be exchangeable or rechargeable.

The consumable 100 is connected, inserted, attached, or otherwise engaged with the aerosol generation device 200 for use. Such a connection may be achieved by any suitable connecting, attaching, or engaging means that may comprise press-fit connections, corresponding electrical connections, mutually engaging portions on the consumable 100 and the aerosol generation device 200, magnetic elements, or any other suitable connection. The consumable 100 comprises a heat transfer element 110 that is in contact with the heating element 210 when the consumable 100 is attached or connected to the aerosol generation device 200. The contact area between the heat transfer element 110 and the heating element 210 should be sufficiently large to ensure that the heat transfer element can be sufficiently heated by the heating element 210. The consumable 100 comprises an aerosol generation substrate 140 that is configured to be or to come into contact with the heat transfer element 110 such that it can be heated by the heat transfer element 110 for generating an aerosol for consumption. The aerosol generation substrate 140 may be an e-liquid or a tobacco substrate. In case of a liquid, the consumable 100 is provided with a liquid storage that may be in direct communication with the heat transfer element 110. The consumable boo may be provided with a sorption member 120 that is in contact with the heat transfer element 110 and in contact with the liquid storage. The heat transfer element 110 heats the liquid absorbed in the sorption member 120 for generating an aerosol for consumption by a user. The consumable 100 is provided with one or more air inlets 101 and an air outlet 102 that may be a mouthpiece or similar arrangement. The flow path of air from the one or more air inlets 101 to the air outlet 102 passes through or is in direct communication with the liquid storage and/or sorption member 120 to allow a generated aerosol to exit through the air outlet 102 for consumption by a user. Alternatively, the air outlet 102 may be provided with the aerosol generation device 200, and air flows from the one or more air inlets 101 to the air outlet 102 via an airflow path that is established when the consumable 100 is attached, connected, and/or in use with the aerosol generation device 200.

The heat transfer element 110 as illustrated in FIG. 1 is at a first temperature that may be an ambient temperature when the consumable is not in use or a temperature when the consumable is in use under normal operation of the aerosol generation device 200 and the consumable 100, i.e. when aerosol is generated for consumption by a user without overheating. Depending on the aerosol generation substrate, overheating may refer to heating the aerosol generation substrate to a too high temperature such that the generated aerosol is of an undesired or even harmful chemical composition. Overheating may also refer to heating the heating element and the heat transfer element to a too high temperature such that the aerosol generation device 200 or the consumable 100 may be damaged. As exemplified in FIG. 1, the heat transfer element 110 is in contact with the heating element 210 with a contact area large enough for being sufficiently heated by the heating element for generating an aerosol.

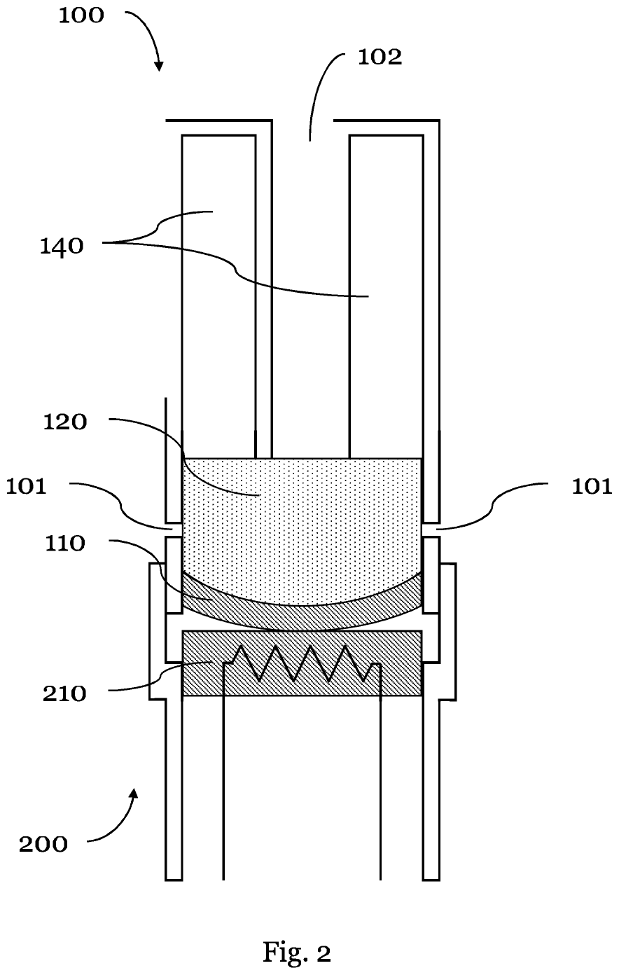

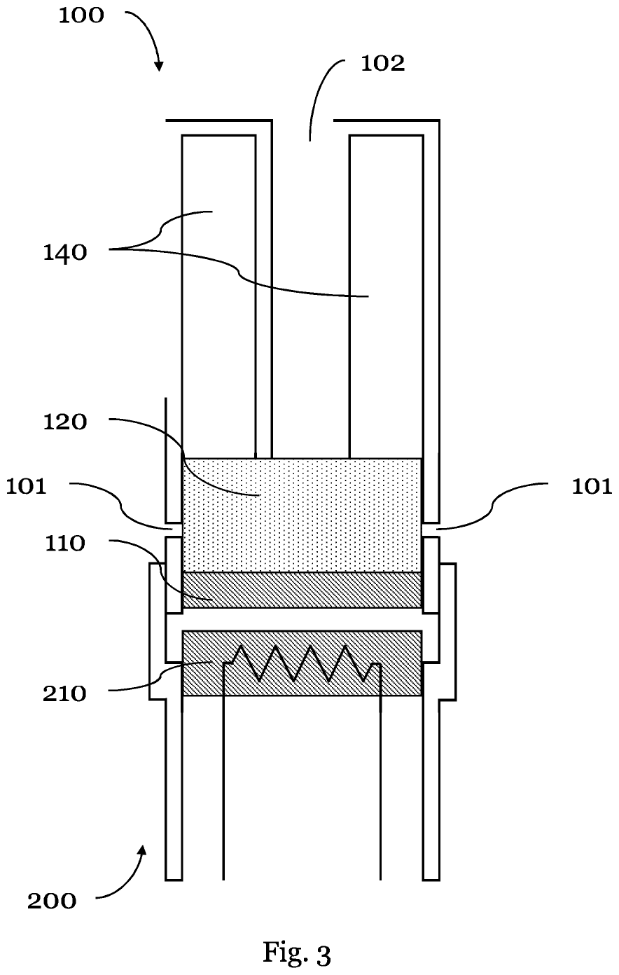

When the heat transfer element is heated to a temperature at or above a threshold temperature that depends on the material composition of the heat transfer element, the heat transfer element is deformed such that the contact area of the contact between the heating element 210 and the heat transfer element 110 is reduced, as exemplified in FIG. 2, or the contact is eliminated, as exemplified in FIG. 3. The heat transfer element 110 may comprise or consists of a strip or a membrane and may be curved or bent such that at least a portion of the heat transfer element 110 is in contact with the heating element 210 due to the bend or curvature when the temperature of the heat transfer element 110 is below the threshold temperature. When the heat transfer element 110 is heated to a temperature at or above the threshold temperature, the heat transfer element 110 that comprises or consists of the strip or membrane is deformed such that the bent or curved strip or membrane becomes at least partially unbent or uncurved or otherwise deformed and at least a portion of the heat transfer element 110 is retracted from the heating element 210. As a result, the contact area of the contact between the heating element 210 and the heat transfer element 110 is reduced, or the contact is eliminated. Alternatively, the heat transfer element 110 may comprise or consist of a coil or spring shape. When the heat transfer element 110 is heated to a temperature at or above the threshold temperature, the coil or spring shape is then deformed such that the coil or spring is shortened and the heat transfer element 110 is retracted from the heating element 210.

When the contact area between the heat transfer element 110 and the heating element 210 is reduced or the contact is eliminated when heat transfer element 110 is at a temperature at or above the threshold temperature, the heating rate of the heat transfer element 110 due to heating by the heating element 210 is reduced or substantially eliminated, and the temperature of the heat transfer element 110 is prevented from further increasing. In this way, overheating of the consumable can be prevented, and the temperature of the heat transfer element and consequently the temperature of the aerosol generation substrate can be controlled to be substantially below the threshold temperature.

When the temperature of the heat transfer element 110 is subsequently at a temperature below the threshold temperature, the heat transfer element may be configured to be substantially reset to its original shape as exemplified in FIG. 1, and the heat transfer element is again in contact with the heating element 210 and can again be heated. The heat transfer element 110 may therefore be configured to act as a temperature switch. Such a configuration may be preferred, for example, if preventing overheating of the aerosol generation substrate is desired. Alternatively, the heat transfer element 110 may be configured to not be substantially reset when its temperature is subsequently at a temperature below the threshold temperature, but to remain deformed. Resetting of the heat transfer element 110 to its original shape in this case may require the application a mechanical force. The heat transfer element may therefore be configured to act as a temperature fuse. Such a configuration may be preferred, for example, if preventing overheating of the consumable 100 and/or aerosol generation device 200 and preventing a potentially damaged consumable 100 and/or aerosol generation device 200 from being further used is desired.

Whether the heat transfer element 110 is configured to perform a switch function or a fuse function depends on the material composition of the heat transfer element 110. The heat transfer element 110 may comprise a material that allows the heat transfer element to act in thermostatic manner, i.e. to keep its temperature at or below a threshold temperature. Additionally, or alternatively, suitable materials for the heat transfer element 110 may comprise shape memory alloys (SMA), bimetallic materials, and magnetic materials with a well-defined Curie temperature. The material of the heat transfer element 110 may be configured to have a threshold temperature in a range of 150° C. to 290° C. A threshold temperature within this temperature range is particularly preferable for an aerosol generation substrate that comprises an e-liquid.

Shape memory alloys are metal alloys that exhibit a shape memory effect. The memory effect can be a one-way memory effect or a two-way memory effect, i.e. they can “remember” one, or two preconfigured shapes to or between which they can transition when the SMA is heated to or above its transformation temperature. This memory effect is based on a phase transition of the metal alloy between a martensite phase and austenite phase with different respective crystal structures when heated to a temperature at or above the transformation temperature and/or when cooled to a temperature below the transformation temperature. Depending on the temperature to which the SMA is heated, the phase transition may be reversible or may not be reversible. An advantage of SMAs is that the phase transition is fast and responsive as it is dependent on the temperature of the SMA, but—in contrast to most phase transitions—independent of time. Therefore, the phase transition of the SMA occurs at the transformation temperature. Referring to FIGS. 1, 2 and 3, the memory effect of an SMA can thus be utilized to allow the heat transfer element 110 to be in a shape as exemplified in FIG. 1 when it is at a temperature below the transformation temperature of the SMA, and to be deformed to a shape as exemplified in FIG. 2 or 3 when the heat transfer element 110 is heated to a temperature at or above the transformation temperature.

For an SMA that exhibits a two-way memory effect, the phase transition is reversible, and the SMA may be repeatedly cycled between two well-defined shapes based on its temperature and thus perform a temperature switch function. In this case, the heat transfer element 110 is configured such that the transformation temperature of the SMA is above the normal operating temperatures for generating an aerosol for consumption and below a temperature at which the aerosol generation substrate and/or consumable and/or aerosol generation device is overheated. When the heat transfer element 110 is at a temperature below the transformation temperature, it is configured to have a first memorized shape as exemplified in FIG. 1 such that the heat transfer element 110 is bent or curved or otherwise shaped to be in contact with the heating element 210. Once the heat transfer element is heated to a temperature at or above the transformation temperature, the heat transfer element 110 is configured to be deformed to a second memorized shape as exemplified in FIG. 2 or 3 due to the above-mentioned phase transition, and as a result, at least a portion of the heat transfer element 110 is retracted from the heating element 210, and the contact area between the heat transfer element 110 and the heating element 210 is reduced or the contact is eliminated. It should be noted that the cycling—the repeated transition between the two memorized shapes—may be subject to hysteresis, i.e. the transformation temperature at or above which the heat transfer element 110 is deformed to the second memorized shape is different and typically higher than the temperature below which the heat transfer element 110 is reset to the first memorized shape.

For an SMA that exhibits a one-way memory effect, the phase transition is irreversible, and the SMA may be deformed to a memorized shape once when heated to or above the transformation temperature, and remains deformed in the memorized shape even when its temperature is subsequently at a temperature below the transformation temperature. Thus, the heat transfer element 110 may perform a fuse function, and the heat transfer element 110 is configured such that the transformation temperature of the SMA is above the normal operating temperatures for generating an aerosol for consumption and below a temperature at which the aerosol generation substrate and/or consumable and/or aerosol generation device is overheated. When the heat transfer element 110 is at a temperature below the transformation temperature, it is configured to have a shape that is preconfigured as exemplified in FIG. 1 such that the heat transfer element 110 is bent or curved or otherwise shaped to be in contact with the heating element 210. Here, the preconfigured shape is not a memorized shape but may be achieved during the manufacturing process. When the heat transfer element 110 is heated to a temperature at or above the transformation temperature, the heat transfer element 110 is deformed to a memorized shape as exemplified in FIG. 2 or 3 due to the above-mentioned non-reversible phase transition, and as a result, at least a portion of the heat transfer element 110 is retracted from the heating element 210, and the contact area between the heat transfer element 110 and the heating element 210 is reduced or the contact is eliminated, and overheating is prevented. Resetting the heat transfer element 110 to its original shape exemplified in FIG. 1 requires application of mechanical forces.

SMA materials may exhibit a one-way memory effect at a first transformation temperature, and a two-way memory effect at a second transformation temperature, wherein the first transformation temperature is different from the second transformation temperature. For example, Cu—Al—Ni is a commonly available SMA that can be configured to have the second transformation temperature at, for example, around 150° C. and to have the first transformation temperature at, for example, around 200° C. Therefore, a heat transfer element 110 comprising Cu—Al—Ni can perform a switch function when it is heated to a temperature at or above the second transformation temperature and below the first transformation temperature, and perform a fuse function when it is heated to a temperature at or above the first transformation temperature.

The different transformation temperatures for the one-way memory effect and the two-way memory effect can be utilized for preventing unauthorized refill and subsequent reuse of a consumable 100 in which the aerosol generation substrate 140 has been depleted due to previous consumption by a user. The heat transfer element 110 may have a second transformation temperature that is configured for preventing overheating of the aerosol generation substrate 140 when the aerosol generation substrate 140 is being heated for generating an aerosol for consumption by the user as long as the aerosol generation substrate 140 is not depleted. Once the aerosol generation substrate 140 is depleted, the heat transfer element 110 cannot transfer heat to the aerosol generation substrate anymore and can consequently be heated to or above the second transformation temperature and is therefore deformed as previously detailed. The heat transfer element 110 is further configured to be heated even when deformed due to the absence of the aerosol generation substrate, and the heat transfer element 110 may thus be heated to or above the first transformation temperature. The heat transfer element 110 will then remain deformed even when it is subsequently cooled to a temperature below the first transformation temperature. Therefore, in the event that the user refills the depleted consumable 100 with an aerosol generation substrate not originally contained in the consumable 100 and reuses the refilled consumable 100, the heat transfer element 110 is already deformed and thus cannot be heated or can only be suboptimally heated by the heating element 210. As a result, generation of an aerosol using the refilled consumable is prevented or substantially reduced.

Cu—Al—Ni is a preferable over other SMAs due to its lower production cost, small hysteresis and high transformation temperature that can be changed by changing the Al or Ni content in the alloy during production.

Alternatively, the heat transfer element 110 may comprise or consist of a bimetallic material. Bimetallic materials typically consist of two different metal materials with different thermal expansion rates that are bonded together. Due to the different thermal expansion rates, when the bimetallic material is heated, the material deforms, and when the bimetallic material is cooled, the material substantially resets to its original shape. In comparison to SMAs, the deformation does not occur at a predetermined transformation temperature. Since the deformation is based on the thermal expansion of the bimetallic material, the deformation is a gradual process that occurs over a temperature range. A heat transfer element 110 comprising or consisting of a bimetallic material may be configured to have a bent or curved shape at a first temperature as exemplified in FIG. 1 to have a contact area between the heating element 210 and the heat transfer element 110 such that the heat transfer element 110 can be sufficiently heated by the heating element 210. The first temperature is preferably within a temperature range for normal operation of the consumable 100 with the aerosol generation device for generating an aerosol for consumption. When the heat transfer element 110 is heated and its temperature increases, due to thermal expansion, the heat transfer element 110 gradually deforms to gradually become unbent or uncurved or otherwise deformed. For example, when the temperature of the heat transfer element 110 increases from a first temperature to a second temperature, the heat transfer element 110 may deform to a shape as exemplified in FIG. 2 such that a portion of the heat transfer element 110 is retracted from the heating element 210 and the contact area between the heat transfer element 110 and heating element 210 is reduced. As a result, the heating rate of the heat transfer element 110 due to heating by the heating element 210 can be reduced. When the heat transfer element 110 is heated to a third temperature, the heat transfer element 110 may gradually deform to a shape as exemplified in FIG. 3 such that the heat transfer element 110 is retracted from the heating element 210, and the contact between the heat transfer element 110 and the heating element 210 is eliminated. The third temperature thus corresponds to the threshold temperature. When the heat transfer element 110 subsequently gradually cools, the heat transfer element 110 gradually deforms to become more bent or curved or otherwise deformed towards the heating element 210 such that at a temperature below the threshold temperature, the heat transfer element 110 again is in contact with the heating element 210. Further cooling of the heat transfer element 110 leads to further curving or bending of the heat transfer element 110 towards the heating element 210, and the contact area between the heat transfer element 110 and heating element 210 is increased again. Therefore, the heat transfer element 110 performs a switching function based on its temperature. Additionally, the heat transfer element 110 performs a temperature regulating function of the heating rate of the heat transfer element 110 within a temperature range below the threshold temperature due to the gradual deformation of the heat transfer element 110 based on its temperature. Alternatively, instead of comprising or consisting of a bent or curved strip or membrane, the heat transfer element 110 may comprise or consist of a coil or spring shape that is configured to retract from the heating element 210 by shortening and to expand towards the heating element 210 by lengthening. The bimetallic material may comprise or substantially consist of commonly available steel-copper or steel-brass materials that have excellent corrosion resistance, mechanical stability, and low production costs.

Alternatively, when the heating element 210 of the aerosol generation device 200 comprises or consists of a magnetic material, the heat transfer element 110 of the consumable 100 may comprise or consist of a magnetic material such that the heating element 210 and heat transfer element 110 exert an attractive magnetic force onto each other. The attractive magnetic force may cause the heat transfer element 110 and the heating element 210 to be in contact when the consumable is attached or connected to the aerosol generation device. The magnetic material of the heat transfer element 110 and/or of the heating element 210 is a magnetic material with a respective Curie temperature above which the magnetic material undergoes a reversible phase change such that the magnetic properties of the magnetic material are reduced or eliminated, while below the Curie temperature the magnetic properties are retained. When the heat transfer element 110 or the heating element 210 is at a temperature at or above the Curie temperature, the attractive magnetic force that causes the heat transfer element 110 and heating element 210 to be in contact is reduced or eliminated, and as a result, the contact area between the heat transfer element 110 and heating element 210 is reduced or the contact is eliminated and overheating is prevented. The Curie temperature is therefore the threshold temperature.

The heat transfer element 110/heating element 210 is configured such that its Curie temperature is above a normal operation temperature for generating an aerosol for consumption. When the heat transfer element 110/heating element 210 is at a temperature below the Curie temperature as exemplified in FIG. 1, the heat transfer element 110 may have a curved or bent shape towards the heating element 210 due to the attractive magnetic force between the heat transfer element 110 and the heating element 210 such that the heat transfer element 110 and the heating element 210 contact each other. The shape of the heat transfer element 110 may additionally be mechanically biased in the direction away from the heating element due to the heat transfer element 110 being bent or curved towards the heating element 210. Alternatively, the mechanical bias may be provided by a spring or coil connected to the heat transfer element 110. When the heat transfer element 110 and/or the heating element 210 is heated to a temperature at or above the respective Curie temperature, the heat transfer element 110 and/or the heating element 210 at least partially loses its magnetic properties, and the attractive magnetic force between the heat transfer element 110 and heating element 210 is reduced or eliminated. Due to the heat transfer element 110 being mechanically biased in a direction away from the heating element 210, the heat transfer element 110 is deformed to be at least partially unbent or uncurved or otherwise deformed such that at least a portion of the heat transfer element 110 is partially retracted from the heating element 210, as exemplified in FIG. 2, or fully retracted from the heating element 210, as exemplified in FIG. 3. The contact area between the heat transfer element 110 and the heating element 210 is reduced or eliminated, and as a result, the heating rate of the heat transfer element 110 due to heating by the heating element 210 is reduced or eliminated, and overheating is prevented. When the temperature of the heat transfer element 110 and/or the heating element 210 is subsequently at a temperature below the Curie temperature, the magnetic material undergoes a reverse phase change, the magnetic properties are substantially restored, and the attractive magnetic force between the heat transfer element 110 and the heating element 210 is substantially restored. As a result, the heat transfer element 110 is deformed to substantially be reset to its original shape as exemplified in FIG. 1. Alternatively, the heat transfer element 110 may comprise a spring or coil shape, and the spring or coil in a state as exemplified in FIG. 1 is decompressed such that it is mechanically biased in a direction away from the heating element 210. When the heat transfer element 110 is at a temperature at or above the Curie temperature, the attractive magnetic force between the heat transfer element 110 and the heating element 210 is reduced or eliminated, the spring or coil shape of the heat transfer element 110 is compressed and thus shortened, and the heat transfer element 110 is retracted from the heating element 210. Therefore, the heat transfer element 110/heating element 210 may perform a temperature switch function with the Curie temperature acting as the threshold temperature. The magnetic material may preferably comprise neodymium due to the strength of the magnetic properties of neodymium.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED

100: consumable
101: air inlet
102: air outlet
110: heat transfer element
120: sorption member
140: aerosol generation substrate
200: aerosol generation device
210: heating element

1. A consumable for use with and attachable to an aerosol generation device comprising a heating element, the consumable comprising:
an aerosol generation substrate; and
a heat transfer element for heating the aerosol generation substrate for generating an aerosol;
wherein the heat transfer element is arranged to be heated by the heating element of the aerosol generation device when the consumable is attached to the aerosol generation device, and
the heat transfer element is configured to be deformed when its temperature is at or above a threshold temperature, such that an area of contact, arranged to exists between the heating element and the heat transfer element when the consumable is attached to the aerosol generation device and a temperature of the heat transfer element is below the threshold temperature, is reduced, or eliminated.

2. (canceled)

3. The consumable according to claim 1, wherein the heat transfer element is configured to be elastically deformed when its temperature is at or above the threshold temperature and to substantially be reset to its original shape when its temperature is subsequently at a temperature below the threshold temperature.

4. The consumable according to claim 1, wherein the heat transfer element comprises a material that exhibits a thermostatic behaviour.

5. The consumable according to claim 1, wherein the heat transfer element comprises a shape memory alloy (SMA), and the threshold temperature corresponds to a transformation temperature of the SMA.

6. The consumable according to claim 5, wherein the heat transfer element is configured to be deformed when its temperature is at or above the transformation temperature such that at least a portion of the heat transfer element can be retracted from the heating element.

7. The consumable according to claim 5, wherein the heat transfer element is configured to substantially remain in its deformed shaped once deformed even when its temperature is subsequently at a temperature below the transformation temperature.

8. The consumable according to claim 1, wherein the heat transfer element comprises a shape memory alloy (SMA), and the threshold temperature corresponds to a transformation temperature of the SMA.

9. The consumable according to claim 8, wherein the heat transfer element is configured to substantially be reset to its original shape when its temperature reaches a temperature below the transformation temperature.

10. The consumable according to claim 9, wherein, if the heat transfer element is at or above a second threshold temperature that is higher than the transformation temperature, the heat transfer element is configured to substantially remain in its deformed shaped once deformed even when its temperature is subsequently at a temperature below the transformation temperature.

11. The consumable according to claim 1, wherein the heat transfer element comprises a bimetallic material.

12. The consumable according to claim 1, wherein the heat transfer element is configured to deform as a function of its temperature such that at or above the threshold temperature, at least a portion of the heat transfer element can be retracted from the heating element.

13. The consumable according to claim 1,
wherein the heat transfer element comprises a magnetic material arranged to provide an attractive magnetic force between the a magnetic material of the heating element and the heat transfer element to establish contact between the heating element and the heat transfer element when the temperature of the heat transfer element is below the threshold temperature.

14. The consumable according to claim 13, wherein the threshold temperature is a Curie temperature of the heat transfer element, and the attractive magnetic force between the heating element and the heat transfer element is configured to be reduced or eliminated at or above the Curie temperature of the heat transfer element such that at least a portion of the heat transfer element is retracted from the heating element.

15. An aerosol generation system comprising:
a consumable according to claim 1; and
an aerosol generation device comprising a heating element configured for heating the heat transfer element of the consumable when the consumable is attached to the aerosol generation device.
